(19) United States
(12) Patent Application Publication
(10) Pub. No.: US 2025/0023699 A1
(43) Pub. Date: Jan. 16, 2025

(54) METHOD FOR DETERMINING CARRIERS, AND DEVICE

(71) Applicant: GUANGDONG OPPO MOBILE TELECOMMUNICATIONS CORP., LTD., Dongguan (CN)

(72) Inventors: Bingxue LENG, Dongguan (CN); Qianxi LU, Dongguan (CN); Boyuan ZHANG, Dongguan (CN)

(21) Appl. No.: 18/903,664

(22) Filed: Oct. 1, 2024

Related U.S. Application Data
(63) Continuation of application No. PCT/CN2022/088783, filed on Apr. 24, 2022.

(51) Int. Cl. H04L 5/00; H04W 72/25; H04W 72/50

(52) U.S. Cl. CPC H04L 5/0092; H04W 72/25; H04W 72/50

(57) ABSTRACT

Provided are methods for determining carriers. The method is applicable to a first terminal and includes: determining a first carrier; and performing sidelink communication with a second terminal over the first carrier. The method is applicable to a second terminal and includes: determining a first carrier by negotiating with a first terminal; and performing sidelink communication with the first terminal over the first carrier.

### CROSS-REFERENCE TO RELATED APPLICATION

This application is a continuation of International Application No. PCT/CN2022/088783, filed Apr. 24, 2022, the entire disclosure of which is incorporated herein by reference.

### TECHNICAL FIELD

The present disclosure relates to the field of sidelink communications, and in particular, relates to a method and an apparatus for determining carriers, and a device and a medium.

### BACKGROUND

In sidelink communication, a first terminal directly transmits sidelink data to a second terminal over sidelink transmission resources, and in this course, the sidelink data does not need to be forwarded by a base station to the second terminal. The sidelink communication may be applicable to device-to-device (D2D) communications.

### SUMMARY

Embodiments of the present disclosure provide a method and an apparatus for determining carriers, and a device and a medium.

According to some embodiments of the present disclosure, a method for determining carriers is provided. The method is applicable to a first terminal, and includes:
determining a first carrier; and
performing sidelink communication with a second terminal over the first carrier.

According to some embodiments of the present disclosure, a method for determining carriers is provided. The method is applicable to a second terminal, and includes:
determining a first carrier by negotiating with a first terminal; and
performing sidelink communication with the first terminal over the first carrier.

According to some embodiments of the present disclosure, a terminal is provided. The terminal includes: a processor; a transceiver, communicably connected to the processor; and a memory, configured to store one or more executable instructions of the processor, wherein the processor, when loading and executing the one or more executable instructions, is caused to perform the method for determining carriers as described above.

According to some embodiments of the present disclosure, a network device is provided. The network device includes: a processor; a transceiver, communicably connected to the processor; and a memory, configured to store one or more executable instructions of the processor, wherein the processor, when loading and executing the one or more executable instructions, is caused to: transmit a carrier configuration to a first terminal, wherein the carrier configuration is configured for the first terminal to determine a first carrier to perform sidelink communication with a second terminal.

### BRIEF DESCRIPTION OF DRAWINGS

For clearer descriptions of the technical solutions according to embodiments of the present disclosure, the accompanying drawings required for describing the embodiments are briefly introduced hereinafter. Apparently, the accompanying drawings in the following description show merely some embodiments of the present disclosure, and those of ordinary skill in the art may still derive other drawings from these accompanying drawings without creative efforts.

FIG. 1 shows a schematic diagram of an operating scenario of sidelink transmission in the related art;

FIG. 2 shows a schematic diagram of an operating scenario of another sidelink transmission in the related art;

FIG. 3 shows a schematic diagram of an operating scenario of another sidelink transmission in the related art;

FIG. 4 shows a schematic diagram of a method for determining carriers according to some schematic embodiments of the present disclosure;

FIG. 5 shows a flowchart of a method for determining carriers according to some schematic embodiments of the present disclosure;

FIG. 6 shows a flowchart of another method for determining carriers according to some schematic embodiments of the present disclosure;

FIG. 7 shows a schematic diagram of another method for determining carriers according to some schematic embodiments of the present disclosure;

FIG. 8 shows a schematic diagram of another method for determining carriers according to some schematic embodiments of the present disclosure;

FIG. 9 shows a schematic diagram of another method for determining carriers according to some schematic embodiments of the present disclosure;

FIG. 10 shows a schematic diagram of another method for determining carriers according to some schematic embodiments of the present disclosure;

FIG. 11 shows a schematic diagram of another method for determining carriers according to some schematic embodiments of the present disclosure;

FIG. 12 shows a schematic diagram of another method for determining carriers according to some schematic embodiments of the present disclosure;

FIG. 13 shows a structural block diagram of an apparatus for determining carriers according to some schematic embodiments of the present disclosure;

FIG. 14 shows a structural block diagram of another apparatus for determining carriers according to some schematic embodiments of the present disclosure;

FIG. 15 shows a structural block diagram of another apparatus for determining carriers according to some schematic embodiments of the present disclosure; and

FIG. 16 shows a schematic structural diagram of a communication device for determining carriers according to some schematic embodiments of the present disclosure.

### DETAILED DESCRIPTION

For clearer descriptions of the objectives, technical solutions, and advantages of the present disclosure, embodiments of the present disclosure are further described in detail below with reference to the accompanying drawings. Exemplary embodiments are described in detail herein, examples of which are illustrated in the accompanying drawings. When the following description relates to the accompanying drawings, the same numerals in different accompanying drawings represent the same or similar elements unless otherwise indicated. The embodiments described in the following exemplary embodiments do not represent all embodiments consistent with the present disclosure. Rather, they are merely examples of apparatus and methods that are described in detail in the appended claims and consistent with certain aspects of the present disclosure.

The terms used in the present disclosure are for the purpose of describing specific embodiments only and are not intended to limit the present disclosure. As used in the present disclosure and the appended claims, the articles “a,” “an,” and “the” are intended to include the plural forms as well, unless the context clearly indicates otherwise. It should also be understood that the phrase “and/or” as used herein refers to and encompasses any or all possible combinations of one or more associated listed items.

It should be understood that although the terms “first,” “second,” “third,” and the like may be used herein to describe various information, such information should not be limited to these terms. These terms are only used to distinguish one type of information from another. For example, first information may also be referred to as second information, and similarly, second information may also be referred to as first information, without departing from the scope of the present disclosure. The word “in a case that,” as used herein, may be interpreted as “in the case that,” “in the case of,” or “when,” “upon,” or “in response to determining” depending on the context.

First, the related technical background content involved in the embodiments of the present disclosure is described as follows.

LTE D2D/V2X: Device-to-device communication is a sidelink (SL) transmission technology based on D2D, also referred to as a sidelink communication technology. The sidelink communication system, unlike the conventional cellular system in which communication data is received or transmitted by a base station, adopts a method of direct device-to-device communication, and thus has higher spectral efficiency and lower transmission delay. In the 3^{rd} Generation Partnership Project (3GPP), two transmission modes are defined for sidelink communication.

Mode A: Transmission resources of a terminal are allocated by a base station, and the terminal transmits data on the sidelink based on the resources allocated by the base station. The base station may allocate resources to the terminal for single transmission, or allocate resources to the terminal for semi-static transmission.

Mode B: A terminal selects resources from a resource pool autonomously for the transmission of data.

In the sidelink communication system, taking the terminal user equipment (UE) described above as an example, the operating scenarios are mainly as follows.

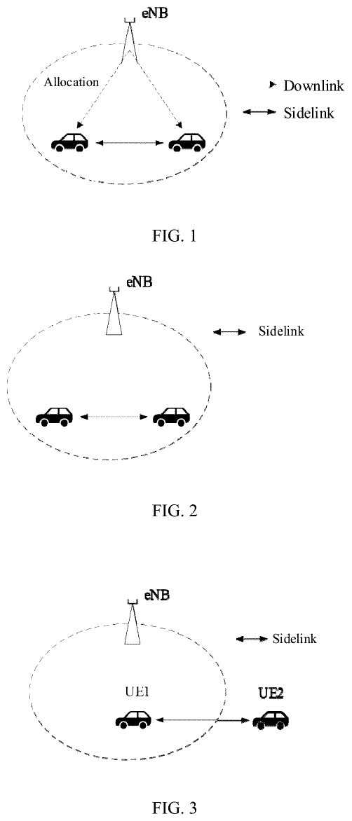

As shown in FIG. 1, two UEs are within network coverage and located in the same cell, a base station allocates sidelink transmission resources to the two UEs, and the two UEs perform data transmission on a sidelink based on the sidelink transmission resources allocated by the base station.

In FIG. 2, two UEs are within network coverage and located in the same cell, and each of the UEs selects resources from a resource pool autonomously to perform data transmission on a sidelink.

In FIG. 3, a UE 1 is located within network coverage, and a UE 2 is located beyond network coverage. The UE 1 is a receiver terminal, and the UE 2 is a transmitter terminal. Alternatively, the UE 1 is a transmitter terminal, and the UE 2 is a receiver terminal. The UE 1 receives transmission resources allocated by a base station to perform sidelink communication with the UE 2, or the UE 1 selects resources from the transmission resources allocated by the base station to perform sidelink communication with the UE 2 based on a configuration requirement transmitted by the UE 2. In addition, the UE 1 selects resources from a resource pool autonomously to perform sidelink communication with the UE 2, or the UE 1 selects resources from the resource pool autonomously to perform sidelink communication with the UE 2 based on a configuration requirement transmitted by the UE 2.

In the 3GPP, D2D has been studied in different stages.

Proximity based service (ProSe): ProSe scenarios have been studied in D2D communication in 3GPP Release 12 and Release 13 (Rel-12/13), which is mainly directed to public safety services. In the ProSe, the position of the resource pool in the time domain is configured, for example, the resource pool is discontinuously configured in the time domain, and therefore, the UE transmits/receives data discontinuously on the SL, such that power saving is achieved.

Vehicle-to-everything (V2X): In Rel-14/15, vehicle-to-vehicle communication scenarios were studied in the V2X system, which is mainly directed to services of relatively high-speed moving vehicle-to-vehicle and vehicle-to-human communications. In the V2X, as the in-vehicle system has a continuous power supply, power efficiency is not a major issue, while the delay of data transmission is a major issue, and therefore, continuous transmission and reception by the terminal device is required in the system design.

Further enhanced device-to-device (FeD2D): In Rel-14, scenarios in which a wearable device accesses a network by a mobile phone have been studied in the FeD2D, which is mainly directed to scenarios with low moving speeds and low power access. In the FeD2D, in the preliminary research phase of 3GPP, it has been concluded that the base station configures the discontinuous reception (DRX) parameter of the remote terminal by one relay terminal, but as the project has not proceeded further into the standardization phase, the details on how to perform DRX configuration are not concluded.

NR V2X: new radio (NR) V2X, based on LTE V2X, is not limited to a broadcast scenario, but is further expanded to unicast and multicast scenarios where V2X applications are studied.

Similar to LTE V2X, NR V2X also defines two resource authorization modes described above, mode A (named as Mode-1 in NR V2X) and mode B (named as Mode-2 in NR V2X). Further, a user may be in a mixed mode, that is, Mode-1 and Mode-2 may be used for resource acquisition simultaneously. The resource acquisition is indicated by means of sidelink authorization, that is, the sidelink authorization indicates a corresponding time-frequency position of physical sidelink control channel (PSCCH) and physical sidelink shared channel (PSSCH) resources.

Unlike LTE V2X, in addition to the feedback-free and UE-initiated hybrid automatic repeat request (HARQ) retransmission, NR V2X introduces feedback-based HARQ retransmission, which is not limited to unicast communication but also includes multicast communication.

NR Uu CA: CA is a supported bandwidth extension technology since the advent of the long term evolution advanced (LTE-Advanced) standard, which allows a plurality of component carriers (CCs) to be aggregated together and received or transmitted simultaneously by one UE. CA may be further classified into intra-band CA and inter-band CA according to the range of aggregated carriers. Intra-band CA is primarily used for scenarios where the bandwidth of a cell carrier is greater than a bandwidth capability of a single carrier of the UE. In this case, the UE is capable of implementing operations in a “wide carrier” by using CA. For example, a base station supports a single carrier of 300 MHZ, while the UE only supports a carrier of a maximum of 100 MHz. In this case, the UE may implement operations for broadband greater than 100 MHz by using CA, and the aggregated carriers may be adjacent carriers or non-adjacent carriers.

In the case that a terminal communicates with a network by using CA, a primary cell (PCell) and a secondary cell (SCell) may be configured simultaneously. In NR R15, a beam failure recovery mechanism is designed for the PCell and a secondary primary cell (PSCell), and implements mainly four functional modules (or main processes):
Beam failure detection (BFD)
New beam identification (NBI)
Beam failure recovery request (BFRQ)
Network side response

The terminal measures a physical downlink control channel (PDCCH) and judges link quality corresponding to a downlink transmission beam. In the case that the link quality is poor, it is considered that a beam failure occurs to the downlink beam. The terminal further measures a set of alternative beams, from which the terminal selects a beam that satisfies a specific threshold as a new beam. The terminal then notifies the network that a beam failure has occurred, and reports the new beam by a BFRQ procedure. Upon receiving BFRQ information from one terminal, the network knows that a beam failure has occurred at the terminal, and chooses to transmit a PDCCH on the new beam. The terminal that receives a PDCCH from the network on the new beam is considered to have correctly received the response information from the network side. As such, the BFRQ procedure is successful.

It should be understood that in some embodiments of the present disclosure, cells and carriers are equivalent. For example, a “first carrier” may be replaced with a “first cell,” a “second carrier” may be replaced with a “second cell,” and so on.

It should be understood that in some embodiments of the present disclosure, a “5G NR system” may also be referred to as a 5G system or an NR system. The technical solutions described in some embodiments of the present disclosure are applicable to 5G NR systems, subsequent evolution systems of the 5G NR systems, or 6G and subsequent evolution systems.

It should be understood that in some embodiments of the present disclosure, “determining carriers” may be understood as “selecting carriers” or “deciding carriers.”

In the related art, the sidelink transmission resources used by the first terminal are selected from a resource pool autonomously or configured by the base station. However, some limitations are placed to the use of the sidelink transmission resources, resulting in limited performance of the sidelink communication system.

In the current NR technology, only the CA technology between a terminal and a base station is supported. The present disclosure provides a method for determining carriers, and the method is applicable to CA-based sidelink communication, namely, the sidelink between two terminals also use the CA technology. In the CA-based sidelink communication, in the case that the sidelink operates on a plurality of carriers, a carrier or a primary carrier is determined and configured by defining a mapping relationship, and/or by network device control, and/or based on negotiation between two terminals, such that the first terminal performs sidelink communication with the second terminal over the determined first carrier or the first primary carrier, and a carrier or a primary carrier to be used in NR SL to perform sidelink data transmission is determined.

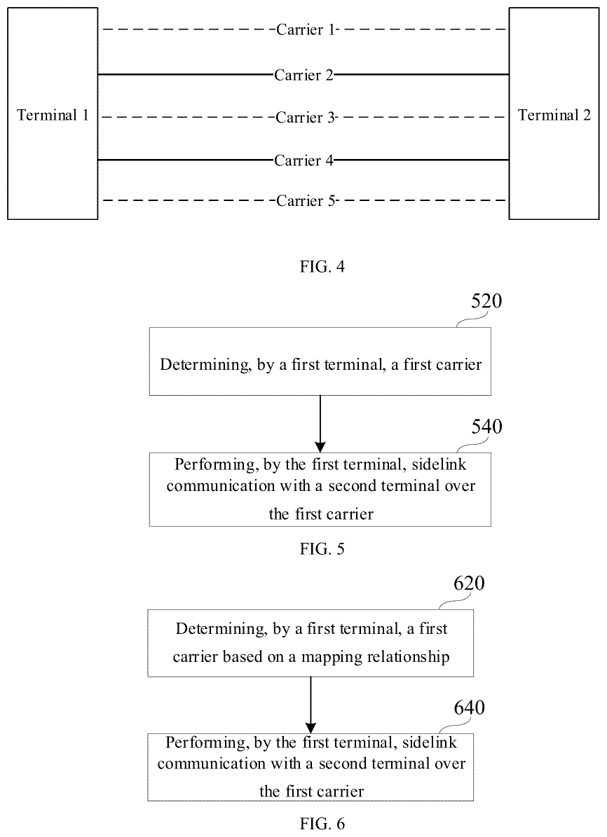

For example, as shown in FIG. 4, a total of five available carriers or candidate carriers are available for sidelink data transmission on the sidelink between a terminal 1 and a terminal 2. The terminal 1 determines that carrier aggregation is performed based on a carrier 2 and a carrier 4, and the terminal 1 performs carrier aggregation-based communication with the terminal 2 over the carrier 2 and the carrier 4.

FIG. 5 shows a flowchart of a method for determining carriers according to some schematic embodiments of the present disclosure. Description is given in the embodiments based on an example in which the method is applicable to a terminal, and the method includes at least some of the following processes.

In process 520, a first terminal determines a first carrier.

The first carrier may be used for unicast communication, or multicast communication, or broadcast communication. The first carrier is one of at least two carriers on a sidelink, or the first carrier is all or part of at least two carriers on the sidelink, or the first carrier is an aggregated carrier of at least two of at least two carriers on the sidelink. The sidelink refers to a link established for sidelink communication between two terminals or a link for achieving sidelink communication, and at least two carriers on the sidelink are at least two available carriers or candidate carriers of the first terminal.

In some embodiments, the first terminal determines the first carrier based on a mapping relationship. The mapping relationship includes a mapping relationship between the attribute of a sidelink and the carrier. The attribute of the sidelink includes at least one of a service type, an application type, a layer 2 identity (ID), a Tx profile, a data transmission type, quality of service (QoS), a logical channel, a resource pool, a radio bearer, a data priority, or a resource pool congestion degree. The resource pool congestion degree is measured based on CBR. The mapping relationship is predefined, or configured by a network device for the first terminal, or configured by a second terminal for the first terminal, or autonomously determined by the first terminal.

The second terminal is a terminal which establishes a sidelink with the first terminal. In unicast communication, one second terminal is deployed; and in multicast or broadcast communication, one or more second terminals are deployed.

In some embodiments, the first terminal determines the first carrier based on the control or configuration by the network device. In some embodiments, the network device configures a carrier set for the first terminal, and the carrier set includes at least two available carriers or candidate carriers. The first terminal determines the first carrier in the carrier set. In some embodiments, the network device configures the first carrier directly to the first terminal.

In some embodiments, the first terminal and the second terminal determine the first carrier by negotiation. The first terminal and the second terminal determine the first carrier by negotiation based on a direct connection communication interface PC5. In some embodiments, in the case that the first terminal is a carrier determiner, the first terminal first determines the first carrier and then notifies the second terminal of the first carrier, or the first terminal and the second terminal confirm whether the first carrier is available. In some embodiments, in the case that the second terminal is a carrier determiner, the second terminal first determines the first carrier and then notifies the first terminal of the first carrier, or the second terminal and the first terminal confirm whether the first carrier is available.

In process 540, the first terminal performs sidelink communication with a second terminal over the first carrier.

The first terminal performs sidelink communication with the second terminal over one of at least two carriers on the sidelink, or the first terminal performs sidelink communication with the second terminal over at least two carriers on the sidelink, or the first terminal performs CA-based sidelink communication with the second terminal over at least two carriers on the sidelink, or the first terminal performs sidelink communication with the second terminal over an aggregated carrier of at least two carriers on the sidelink, or the first terminal performs CA-based sidelink communication with the second terminal over an aggregated carrier of at least two carriers on the sidelink.

In some embodiments, the terminal has a CA or dual connectivity (DC) capability.

In some embodiments, the terminal does not have a CA or DC capability, or the terminal has a CA or DC capability but does not enable CA or DC.

In some embodiments, the first terminal and the second terminal are both within network coverage and located in the same cell.

In some embodiments, the first terminal and the second terminal are both within network coverage but located in different cells.

In some embodiments, the first terminal is within network coverage, and the second terminal is beyond network coverage.

In some embodiments, the first terminal is beyond network coverage, and the second terminal is within network coverage.

In some embodiments, the first terminal and the second terminal are both beyond network coverage.

In some embodiments, the first terminal is a transmitter terminal and the second terminal is a receiver terminal; and/or the first terminal is a receiver terminal and the second terminal is a transmitter terminal.

The method described above is applicable to sidelink communication scenarios based on Mode-1 and/or sidelink communication scenarios based on Mode-2.

In summary, in the method according to the embodiments, by using a more flexible carrier determination and configuration mechanism, with the introduction of CA, a proper carrier may be determined or at least two carriers may be used for CA, such that the data transmission performance on the sidelink is improved, and the transmission performance of the sidelink communication system is enhanced.

### Candidate Method 1: Determining First Carrier Based on a Mapping Relationship

FIG. 6 shows a schematic diagram of a method for determining carriers according to some exemplary embodiments of the present disclosure. Description is given in the embodiments based on an example in which the method is applicable to a terminal, and the method includes at least some of the following processes.

In process 620, a first terminal determines a first carrier based on a mapping relationship.

The mapping relationship is configured to define a determination rule for a carrier or a main carrier, and includes a mapping relationship between the attribute of a sidelink and the carrier. The attribute of the sidelink includes at least one of a service type, an application type, a layer 2 ID, a Tx profile, a data transmission type, QoS, a logical channel, a resource pool, a radio bearer, a data priority, or a resource pool congestion degree. The mapping relationship is predefined, or configured by a network device for the first terminal, or configured by a second terminal for the first terminal, or autonomously determined by the first terminal.

The second terminal is a terminal which establishes a sidelink with the first terminal. In unicast communication, the number of the second terminal is one, and in multicast or broadcast communication, the number of the second terminal is one or more.

The first carrier may be used for unicast communication, or multicast communication, or broadcast communication.

In some embodiments, the mapping relationship is defined by a non-access stratum (NAS) and/or defined by an access stratum (AS).

The NAS includes a protocol stack or a function in communication between a core network element and a terminal, and is configured to support signaling and data transmission between the core network element and the terminal. Illustratively, the NAS involves: mobility management (MM), session management (SM), call control (CC), short message service (SMS), and the like.

The AS includes a protocol stack or a function in communication between an access network element and a terminal. Illustratively, the AS involves: Service Data Adaptation Protocol (SDAP), Packet Data Convergence Protocol (PDCP), radio link control (RLC), medium-access control (MAC), and physical layer (PHY).

In some embodiments, the mapping relationship is defined by the NAS. The mapping relationship includes, but is not limited to, at least one of the following relationships.

### Mapping Relationship Between Service Type and Candidate Carrier

For example, a service type A corresponds to a candidate carrier 1, and a service type B corresponds to a candidate carrier 2. In the case that the service type of the to-be-transmitted data of the first terminal is the service type A, the candidate carrier 1 is determined as the first carrier based on the mapping relationship; and in the case that the service type of the to-be-transmitted data of the first terminal is the service type B, the candidate carrier 2 is determined as the first carrier based on the mapping relationship.

### Mapping Relationship Between Application Type and Candidate Carrier

For example, the application type “multimedia player application” corresponds to a candidate carrier 1, and the application type “calling application” corresponds to a candidate carrier 2. In the case that the application type of the to-be-transmitted data of the first terminal is the “multimedia player application,” the candidate carrier 1 is determined as the first carrier based on the mapping relationship; and in the case that the application type of the to-be-transmitted data of the first terminal is the “calling application,” the candidate carrier 2 is determined as the first carrier based on the mapping relationship.

### Mapping Relationship Between Layer 2 ID and Candidate Carrier

For example, the layer 2 includes: an SDAP layer, a PDCP layer, an RLC layer, and a MAC layer. For example, the layer 2 ID is an identifier with a length of 24 bits.

For example, an ID set 1 corresponds to a candidate carrier 1, and an ID set 2 corresponds to a candidate carrier 2. In the case that the layer 2 ID of the to-be-transmitted data of the first terminal belongs to the ID set 1, the candidate carrier 1 is determined as the first carrier based on the mapping relationship; and in the case that the layer 2 ID of the to-be-transmitted data of the first terminal belongs to the ID set 2, the candidate carrier 2 is determined as the first carrier based on the mapping relationship.

### Mapping Relationship Between Tx Profile and Candidate Carrier

The Tx profile indicates whether the terminal supports some characteristics, functions, or capabilities of the NR. For example, the Tx profile indicates whether the terminal supports DRX. Illustratively, the terminal supports a corresponding candidate carrier 1, or the terminal does not support a candidate carrier 2 corresponding to DRX. In the case that the Tx profile of the first terminal supports DRX, the candidate carrier 1 is determined as the first carrier based on the mapping relationship; and in the case that the Tx profile of the first terminal does not support the DRX, the candidate carrier 2 is determined as the first carrier based on the mapping relationship. Alternatively, the Tx profile indicates whether multi-carrier sidelink communication is supported. Illustratively, the Tx profile indicates that the candidate carrier 1 (e.g., the R16/17 carrier) corresponding to the multi-carrier communication is not supported, or the Tx profile indicates that the candidate carrier 2 (e.g., the R18 carrier) corresponding to the multi-carrier communication is supported. In the case that the Tx profile of the first terminal does not support the multi-carrier communication, the candidate carrier 1 is determined as the first carrier based on the mapping relationship; and in the case that the Tx profile of the first terminal supports the multi-carrier communication, the candidate carrier 2 is determined as the first carrier based on the mapping relationship.

### Mapping Relationship Between Data Transmission Type and Candidate Carrier

The data transmission type includes at least one of unicast type, multicast type, or broadcast type. For example, the unicast type corresponds to a candidate carrier 1, the multicast type corresponds to a candidate carrier 2, and the broadcast type corresponds to a candidate carrier 3. In the case that the sidelink communication between the first terminal and the second terminal is of a unicast type, the candidate carrier 1 is determined as the first carrier based on the mapping relationship.

In some embodiments, the mapping relationship is defined by the AS, including but not limited to at least one of the following relationships.

### Mapping Relationship Between QoS Flow and Candidate Carrier

For example, a QoS flow 1 corresponds to a candidate carrier 1, and QoS flow 2 corresponds to a candidate carrier 2. In the case that the QoS flow of the to-be-transmitted data of the first terminal is the QoS flow 1, the candidate carrier 1 is determined as the first carrier based on the mapping relationship; and in the case that the QoS flow of the to-be-transmitted data of the first terminal is the QoS flow 2, the candidate carrier 2 is determined as the first carrier based on the mapping relationship.

### Mapping Relationship Between Logical Channel and Candidate Carrier

For example, a logical channel 1 corresponds to a candidate carrier 1, and a logical channel 2 corresponds to a candidate carrier 2. In the case that the logical channel of the to-be-transmitted data of the first terminal is the logical channel 1, the candidate carrier 1 is determined as the first carrier based on the mapping relationship; and in the case that the logical channel of the to-be-transmitted data of the first terminal is the logical channel 2, the candidate carrier 2 is determined as the first carrier based on the mapping relationship.

### Calculation Formula of Layer 2 ID to Candidate Carrier

The layer 2 ID is made to corresponded to a candidate carrier by defining a calculation rule, for example, in the case that the number of the candidate carrier is N, the layer 2 ID is divided by N to obtain a remainder. In the case that the remainder is 0, a candidate carrier 0 is determined as the first carrier based on the mapping relationship; in the case that the remainder is 1, a candidate carrier 1 is determined as the first carrier based on the mapping relationship; in the case that the remainder is 2, a candidate carrier 2 is determined as the first carrier based on the mapping relationship.

### Mapping Relationship Between Resource Pool and Candidate Carrier

For example, a resource pool 1 corresponds to a candidate carrier 1, and a resource pool 2 corresponds to a candidate carrier 2. In the case that the resource pool of the to-be-transmitted data of the first terminal is the resource pool 1, the candidate carrier 1 is determined as the first carrier based on the mapping relationship; and in the case that the resource pool of the to-be-transmitted data of the first terminal is the resource pool 2, the candidate carrier 2 is determined as the first carrier based on the mapping relationship.

### Mapping Relationship Between Radio Bearer and Candidate Carrier

For example, a signaling radio bearer (SRB) corresponds to a candidate carrier 1, and a data radio bearer (DRB) corresponds to a candidate carrier 2. In the case that the radio bearer of the to-be-transmitted data of the first terminal is the SRB, the candidate carrier 1 is determined as the first carrier based on the mapping relationship; and in the case that the radio bearer of the to-be-transmitted data of the first terminal is the DRB, the candidate carrier 2 is determined as the first carrier based on the mapping relationship. Alternatively, a radio bearer 1 corresponds to the candidate carrier 1, and a radio bearer 2 corresponds to the candidate carrier 2. In the case that the radio bearer of the to-be-transmitted data of the first terminal is the radio bearer 1, the candidate carrier 1 is determined as the first carrier based on the mapping relationship; and in the case that the radio bearer of the to-be-transmitted data of the first terminal is the radio bearer 2, the candidate carrier 2 is determined as the first carrier based on the mapping relationship.

### Default Set of Candidate Carriers

### Mapping Relationship Between Data Priority and Candidate Carrier

For example, a data priority 1 corresponds to a candidate carrier 1, and a data priority 2 corresponds to a candidate carrier 2. In the case that the data priority of the to-be-transmitted data of the first terminal is the data priority 1, the candidate carrier 1 is determined as the first carrier based on the mapping relationship; and in the case that the data priority of the to-be-transmitted data of the first terminal is the data priority 2, the candidate carrier 2 is determined as the first carrier based on the mapping relationship.

### Mapping Relationship Between Resource Pool Congestion Degree and Candidate Carrier.

For example, a resource pool congestion degree 1 corresponds to a candidate carrier 1, and a resource pool congestion degree 2 corresponds to a candidate carrier 2. It is assumed that the resource pool congestion degree 1 is represented by a first threshold, and the resource pool congestion degree 2 is represented by a second threshold, and the first threshold is less than the second threshold. In the case that the resource pool congestion degree measured by the first terminal is less than the first threshold, the candidate carrier 1 is determined as the first carrier based on the mapping relationship; and in the case that the resource pool congestion degree measured by the first terminal is greater than the first threshold and less than the second threshold, the candidate carrier 2 is determined as the first carrier based on the mapping relationship.

In some embodiments, one or more candidate carriers are deployed.

In some embodiments, the methods for configuring the mapping relationship include at least one of: pre-configuration, network device configuration, second terminal configuration, or first terminal configuration. The second terminal configuration refers to that the mapping relationship is configured by the second terminal for the first terminal, and the first terminal configuration refers to that the mapping relationship is configured by the first terminal for the second terminal.

In some embodiments, the network device configuration includes at least one of signaling configuration or system information configuration. The dedicated signaling refers to signaling applicable to the first terminal or a terminal group to which the first terminal belongs, and the system information configuration refers to signaling applicable to all terminals or most terminals in a serving cell.

In some embodiments, the mapping relationships described above are used alone or in combination.

In process 640, the first terminal performs sidelink communication with a second terminal over the first carrier.

The first terminal performs sidelink communication with the second terminal over the first carrier determined based on the mapping relationship defined by the NAS, or the first terminal performs sidelink communication with the second terminal over the first carrier determined based on the mapping relationship defined by the AS, or the first terminal performs CA-based sidelink communication with the second terminal over the first carrier determined based on the mapping relationship defined by the NAS, or the first terminal performs CA-based sidelink communication with the second terminal over the first carrier determined based on the mapping relationship defined by the AS, or the first terminal performs sidelink communication with the second terminal over the first carrier determined based on the mapping relationship defined by the NAS and the AS, or the first terminal performs CA-based sidelink communication with the second terminal over the first carrier determined based on the mapping relationship defined by the NAS and the AS.

In some embodiments, the terminal has a CA or DC capability.

In some embodiments, the first terminal and the second terminal are both within network coverage and located in the same cell.

In some embodiments, the first terminal and the second terminal are both within network coverage but located in different cells.

In some embodiments, the first terminal is within network coverage, and the second terminal is beyond network coverage.

In some embodiments, the first terminal and the second terminal are both beyond network coverage.

In summary, in the method according to the embodiments, a network device is not required to control the determination process of the first carrier, and the first terminal autonomously determines the first carrier based on a mapping relationship, such that the signaling resource consumption between the terminal and the network device is reduced. Even in the case that the first terminal is in a non-connected state or is beyond network coverage, the first terminal can autonomously determine the first carrier to perform sidelink communication, such that the data transmission performance on the sidelink is improved.

### Candidate Method 2: Determining First Carrier Based on Configuration of Network Device.

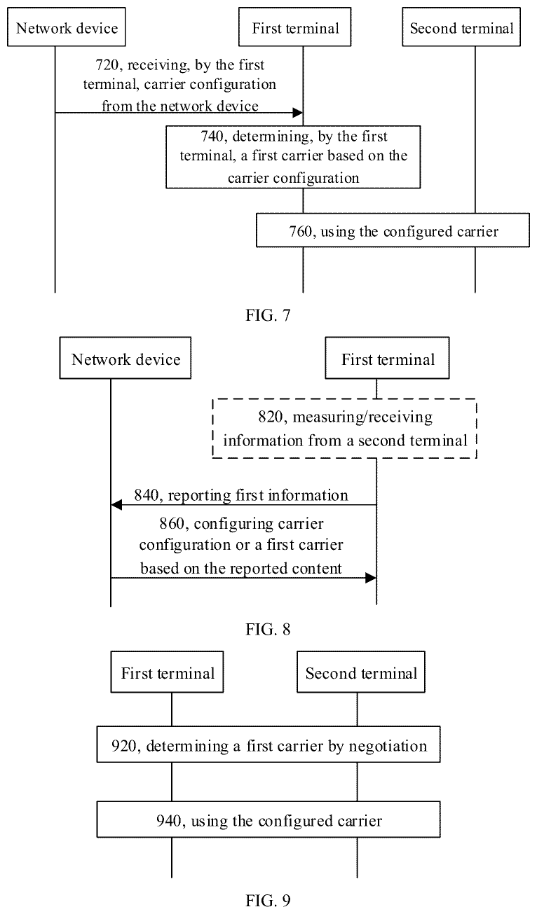

FIG. 7 shows a schematic diagram of a method for determining carriers on a sidelink according to some other exemplary embodiments of the present disclosure. Description is given in the embodiments based on an example in which the method is applicable to a terminal, and the method includes at least some of the following processes.

In process 720, a first terminal receives carrier configuration from a network device.

The carrier configuration is that upon the first terminal reports information, such as transmission information, channel information, or interest of the first terminal to the network device, the network device configures a suitable carrier or main carrier resource, an available carrier or available carrier set, or a candidate carrier or candidate carrier set for the first terminal based on the reported content.

The carrier configuration may be used for unicast communication, or multicast communication, or broadcast communication.

The carrier configuration is applicable to at least one of the following scenarios.
The network device supports the multi-carrier mechanism of a sidelink.
The first terminal is in a connected state.
The first terminal is in Mode-1 in the sidelink.
The first terminal is in Mode-2 in the sidelink.

In one example, the network device supports the multi-carrier mechanism of the sidelink, the first terminal is in a connected state, and the first terminal is in Mode-1 in the sidelink. In another example, the network device supports the multi-carrier mechanism of the sidelink, the first terminal is in a connected state, and the first terminal is in Mode-2 in the sidelink.

The terminal determines whether the network device supports the multi-carrier or CA mechanism on the sidelink, by explicitly transmitting the indication of supporting multi-carrier or CA on the sidelink by the network device, or implicitly transmitting the multi-carrier or CA configuration of the sidelink by the network device. Upon receiving the explicit indication or implicit configuration of the network device, the terminal determines that the network device supports the multi-carrier or CA mechanism on the sidelink.

In the case that the first terminal is in Mode-1, sidelink transmission resources of the first terminal are allocated by the network device, and the first terminal transmits data on the sidelink based on the sidelink transmission resources allocated by the network device. The network device allocates sidelink transmission resources to the first terminal for single transmission, or allocates sidelink transmission resources to the first terminal for semi-static transmission. In the case that the first terminal is in Mode-2, the first terminal selects sidelink transmission resources from a resource pool autonomously to perform data transmission on the sidelink. In the case that the first terminal is in a mixed mode of Mode-1 and Mode-2, sidelink transmission resources are acquired by using either Mode-1 or Mode-2, such that data transmission is performed on the sidelink.

In some embodiments, prior to process 720, the first terminal further transmits first information to the network device, the first information is information configured to assist the network device in configuring carrier configuration. For example, the first information includes at least one of: channel measurement result, capability information of first terminal, capability information of second terminal, interest of first terminal, QoS information of sidelink, target layer 2 ID information of sidelink, Logical channel identification information of sidelink, carrier configuration proposed or desired by first terminal, or carrier configuration proposed or desired by second terminal.

### Channel Measurement Result

The result includes channel condition information acquired upon the channel measurement by the first terminal, for example, link quality or resource pool congestion degree.

### Capability Information of First Terminal

The information includes capability information supported by the first terminal, capability information upon leaving the factory, capability information upon upgrading, capability information acquired upon measurement, or pre-configured capability information, for example, whether CA is supported, whether DC is supported, supported carriers, or supported frequencies.

### Capability Information of Second Terminal

The information includes the capability information of the second terminal actively transmitted by the second terminal to the first terminal, or capability information fed back to the first terminal by the second terminal in response to an inquiry about the capability information, for example, whether CA is supported, whether DC is supported, supported carriers, or supported frequencies.

### Interest of First Terminal

The interest information indicates a carrier or service in which the first terminal is interested.

### QoS Information of Sidelink

The QoS information of the sidelink is determined based on information, such as service type, priority, or the like of the to-be-transmitted data. The to-be-transmitted data is the to-be-transmitted data of the first terminal or to-be-transmitted data of the second terminal.

In the case that the to-be-transmitted data is the to-be-transmitted data of the second terminal, the second terminal actively transmits the service type of the to-be-transmitted data to the first terminal, or in response to the inquiry from the first terminal to the second terminal, the second terminal feeds back the service type of the to-be-transmitted data to the first terminal.

### Target Layer 2 ID Information of Sidelink

The target layer 2 ID information of the sidelink is the layer 2 ID information of the receiver terminal

In the case that the to-be-transmitted data is the to-be-transmitted data of the first terminal, the second terminal actively transmits the layer 2 ID information of the second terminal to the first terminal, or in response to the inquiry from the first terminal to the second terminal, the second terminal feeds back the layer 2 ID information of the second terminal to the first terminal.

### Logical Channel Identification Information of Sidelink

The information includes logical channel identification information acquired upon measuring the sidelink by the first terminal, or pre-configured logical channel identification information, or logical channel identification information actively reported to the first terminal by the second terminal, or in response to the inquiry from the first terminal to the second terminal, logical channel identification information fed back to the first terminal by the second terminal.
Carrier configuration proposed or desired by first terminal.
Carrier configuration proposed or desired by second terminal.

The configuration includes proposed or desired carrier configuration actively reported to the first terminal by the second terminal, or in response to the inquiry from the first terminal to the second terminal, proposed or desired carrier configuration fed back to the first terminal by the second terminal.

The second terminal is a terminal which establishes a sidelink with the first terminal. In unicast communication, the number of the second terminal is one, and in multicast or broadcast communication, the number of the second terminal is one or more, assuming that the first terminal is a transmitter terminal.

In process 740, the first terminal determines a first carrier based on the carrier configuration.

The carrier configuration carries one or more carriers.

The first carrier is all or part of carriers configured by the network device for the first terminal, or one carrier in the carrier configuration configured by the network device, or at least two carriers in the carrier configuration configured by the network device, or an aggregated carrier of at least two carriers in the carrier configuration configured by the network device.

The first terminal determines the first carrier in the received carrier configuration.

In some embodiments, the first terminal determines all or part of the carriers of the carrier configuration as the first carrier based on an indication of the network device. In some embodiments, the first terminal autonomously determines all or part of the carriers of the carrier configuration as the first carrier, for example, the first terminal determines at least one carrier of the carrier configuration as the first carrier based on a mapping rule, or a determination and configuration or determination rule. In some embodiments, the first terminal and the second terminal determine at least one carrier of the carrier configuration as the first carrier by negotiation.

In process 760, the first terminal performs sidelink communication with a second terminal over the configured first carrier.

The first terminal performs sidelink communication with the second terminal over the determined first carrier, or the first terminal performs CA-based sidelink communication with the second terminal over at least one carrier in the carrier configuration, or the first terminal performs sidelink communication with the second terminal over one carrier in the carrier configuration, or the first terminal performs CA-based sidelink communication with the second terminal over one carrier in the carrier configuration, or the first terminal performs sidelink communication with the second terminal over at least two carriers in the carrier configuration, or the first terminal performs CA-based sidelink communication with the second terminal over at least two carriers in the carrier configuration, or the first terminal performs sidelink communication with the second terminal over an aggregated carrier of at least two carriers in the carrier configuration, or the first terminal performs CA-based sidelink communication with the second terminal over an aggregated carrier of at least two carriers in the carrier configuration.

In some embodiments, the terminal has a CA or DC capability.

In some embodiments, the first terminal and the second terminal are both within network coverage and located in the same cell.

In some embodiments, the first terminal and the second terminal are both within network coverage but located in different cells.

In some embodiments, the first terminal is within network coverage, and the second terminal is beyond network coverage.

In some embodiments, the first terminal is beyond network coverage, and the second terminal is within network coverage.

In some embodiments, the first terminal and the second terminal are both beyond network coverage.

In summary, in the method according to the embodiments, the network device controls or configures carrier resources for the first terminal, and then the first terminal determines the first carrier to perform sidelink communication based on the carrier configuration. The network device coordinates the carrier configuration of different terminals, such that the success rate and stability of the carrier configuration on the sidelink are improved, and thus the transmission performance of the sidelink communication system is enhanced.

FIG. 8 shows a flowchart of a method for determining carriers according to some exemplary embodiments of the present disclosure. The flow includes at least some of the following processes.

In process 820, a first terminal measures channel condition or receives information from a second terminal.

The channel condition includes, but is not limited to: the link quality of the sidelink, for example, reference signal received power (RSRP), or resource pool congestion degree, for example, channel busy ratio (CBR) and channel occupancy ratio (CR).

The information from the second terminal includes, but is not limited to at least one of: capability information of the second terminal, for example, whether CA is supported, whether DC is supported, supported carriers, or supported frequencies; carrier configuration proposed by the second terminal; or carrier configuration desired by the second terminal.

In process 840, the first terminal reports first information to a network device.

The first information is configured to assist the network device in configuring carrier configuration, and is transmitted by the first terminal to the network device.

The first information includes, but is not limited to, at least one of:

Channel measurement result, e.g., RSRP, CBR, or CR.
Capability information of first terminal, e.g., whether CA is supported, whether DC is supported, supported carriers, or supported frequencies.
Capability information of second terminal, e.g., whether CA is supported, whether DC is supported, supported carriers, or supported frequencies.
Interest of first terminal, e.g., whether sidelink data transmission is required, and what type of data transmission is to be performed. The to-be-transmitted data includes, but is not limited to, data type (communication data and/or discovery messages, etc.) or data transmission type (unicast, or multicast, or broadcast), etc.
QOS information of sidelink.
Target layer 2 ID information of sidelink.
Logical channel identification information of sidelink.
Carrier configuration proposed by first terminal.
Carrier configuration desired by first terminal.
Carrier configuration proposed by second terminal.
Carrier configuration desired by second terminal.

In process 860, the network device configures carrier configuration or a first carrier for the first terminal based on the first information.

The network device receives the first information reported by the first terminal, and configures a suitable carrier resource or the first carrier for the first terminal based on the first information, wherein the carrier resource is carrier configuration configured by the network device for the first terminal.

The carrier configuration is applicable to unicast communication, or multicast communication, or broadcast communication.

The first carrier can be used for unicast communication, or multicast communication, or broadcast communication. The first carrier is one carrier of at least two carriers on a sidelink, or the first carrier is at least two of at least two carriers on the sidelink, or the first carrier is an aggregated carrier of at least two of at least two carriers on the sidelink. The sidelink refers to a link established for sidelink communication between two terminals or a link for achieving sidelink communication, and the at least two carriers on the sidelink are at least two available carriers or candidate carriers of the first terminal.

For example, both UE1 and UE2 are within network coverage and located in the same cell. The UE1 measures the channel condition of the sidelink, and the measurement result indicates that the RSRP is too low and the CBR is too high, which is not conducive to the transmission of communication data or discovery messages, and therefore the UE1 wants to perform CA-based sidelink communication with the UE2. The UE1 receives information from the UE2, wherein the information includes the UE2 supporting CA, supported carrier frequencies, proposed carrier configuration, etc. The UE1 reports first information to the network device, and the first information includes channel measurement result of the UE1, capability information of the UE2, carrier configuration proposed by the UE2, QoS information of the sidelink, carriers supported by the UE1, frequencies supported by the UE1, and the like. The network device configures a carrier for the UE1 based on the first information transmitted by the UE1, such that the carrier configuration conforms to the capabilities and desires of the UE1 and the UE2.

### Candidate Method 3: Determining First Carrier Based on Negotiation Between First Terminal and Second Terminal.

FIG. 9 shows a schematic diagram of a method for determining carriers according to some other exemplary embodiments of the present disclosure. Description is give based on an example in which the method is applicable to a terminal, and the method includes at least some of the following processes.

In process 920, a first terminal and a second terminal determine a first carrier by negotiation.

The first terminal and the second terminal determine the first carrier based on a PC5 interface or PC5-radio resource control (RRC). The first carrier is used for unicast communication between the first terminal and the second terminal, and the first carrier is one carrier determined by negotiation between the first terminal and the second terminal, at least two carriers determined by negotiation between the first terminal and the second terminal, or an aggregated carrier of at least two carriers determined by negotiation between the first terminal and the second terminal.

In some embodiments, the first terminal is a transmitter terminal and the second terminal is a receiver terminal.

In some embodiments, the first terminal is a receiver terminal and the second terminal is a transmitter terminal.

The negotiation process between the first terminal and the second terminal includes: transmitting, by the first terminal, carrier configuration to the second terminal, wherein the carrier configuration indicates one carrier, or at least two carriers, or an aggregated carrier of at least two carriers determined by the first terminal; and receiving, by the first terminal, a configuration response of the second terminal, wherein the configuration response includes configuration acceptance, configuration rejection, configuration completion, configuration failure, or the like.

In some embodiments, the carrier configuration transmitted by the first terminal to the second terminal is autonomously selected or generated by the first terminal.

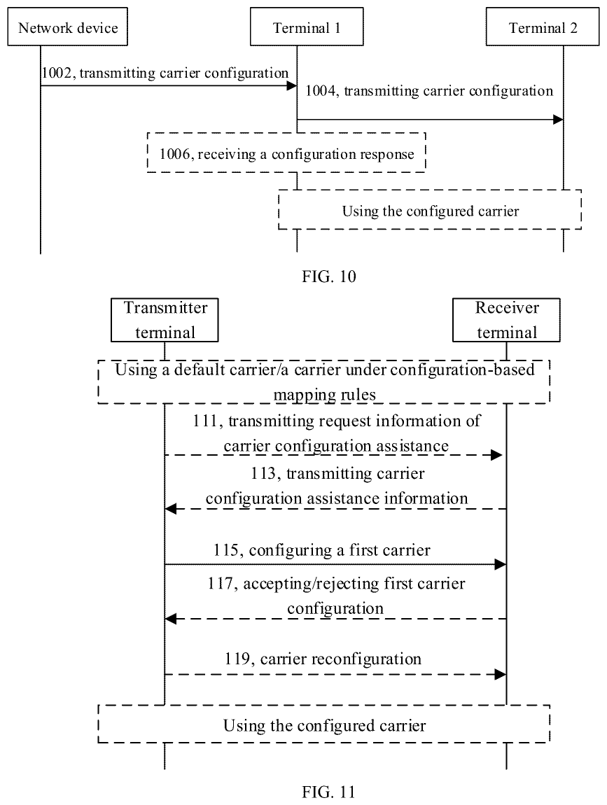

In some embodiments, the carrier configuration transmitted by the first terminal to the second terminal is configured by the network device for the first terminal. For example, as shown in FIG. 10, the configuration method further includes at least some of the following processes.

In process 1002, a network device transmits carrier configuration to a first terminal, wherein the carrier configuration includes one carrier, or at least two carriers, or an aggregated carrier of at least two carriers.

In process 1004, the first terminal transmits the carrier configuration to a second terminal.

In process 1006, the first terminal receives a configuration response of the second terminal, wherein the configuration response may be configuration acceptance, configuration rejection, configuration success, configuration failure, or the like.

In some embodiments, the second terminal accepts carrier configuration from the first terminal and transmits a configuration response to the first terminal; or the second terminal directly uses or enables or activates the carrier configuration and considers the configuration to be successful without transmitting a configuration response to the first terminal. The first terminal and the second terminal then use the carrier configuration to perform sidelink communication.

In some embodiments, the second terminal rejects carrier configuration from the first terminal, or considers the configuration to be failed, feeds back a rejection reason to the first terminal, or proposes new carrier configuration to the first terminal.

In the case that the configuration response indicates that the second terminal rejects configuration or configuration fails, the first terminal performs at least one of the operations of carrier reconfiguration, radio link failure (RLF), or link disconnection.

In some embodiments, prior to transmitting carrier configuration by the first terminal to the second terminal, the second terminal transmits carrier configuration assistance information to the first terminal. Carrier configuration assistance information is information configured to assist the first terminal in determining information of a carrier or a main carrier by negotiation, and is transmitted by the second terminal to the first terminal.

For example, carrier configuration assistance information is transmitted by the second terminal in the case that at least one of the following trigger modes is satisfied.
Receiving request information of carrier configuration assistance from first terminal.
A periodically triggered mode.
An event-triggered mode.

For example, the second terminal confirms that the first terminal has a CA, DC, or multi-carrier sidelink communication capability, and periodically transmits carrier configuration assistance information to the first terminal. The period value may be a fixed value, or a default value, or a value configured by the network device, or a value configured by the second terminal, or a value autonomously determined by the first terminal.

For example, the second terminal confirms that the first terminal has a CA, DC, or multi-carrier sidelink communication capability, and transmits carrier configuration assistance information to the first terminal in the case that at least one of the following events occurs.
A desired carrier or carrier set changes.
The first terminal and the second terminal establish a unicast communication link.
The second terminal has not transmitted carrier configuration assistance information.
Carriers of links other than the sidelink change.
The link quality of the sidelink deteriorates.
Conflict is detected on the sidelink.

For example, carrier configuration assistance information is generated by the second terminal with reference to at least one of: information carried in request information of carrier configuration assistance; carriers used by links other than the sidelink; and the link quality or channel condition of the candidate carrier.

For example, carrier configuration assistance information includes a carrier or carrier set desired by the second terminal.

In some embodiments, prior to transmitting carrier configuration assistance information by the second terminal to the first terminal, the first terminal further transmits request information of carrier configuration assistance to the second terminal. Request information of carrier configuration assistance is information configured to assist the terminal in determining a carrier or a main carrier by negotiation, and is transmitted by the first terminal to the second terminal.

For example, request information of carrier configuration assistance is transmitted by the first terminal in the case that at least one of the following conditions is satisfied.
Upon capability interaction, the first terminal confirms that the second terminal has a CA, DC, or multi-carrier sidelink communication capability.
The first terminal and the second terminal establish a unicast communication link.
The first terminal has not transmitted request information of carrier configuration assistance.
The data transmission between the first terminal and the second terminal changes.
The first terminal has performed resource reselection.
The first terminal has performed carrier reselection.

For example, request information of carrier configuration assistance includes at least one of: request indication, or data characteristics of the to-be-transmitted data, e.g., QoS information, a traffic pattern, or a priority.

In process 940, the first terminal performs sidelink communication with the second terminal over the configured first carrier.

The first terminal performs CA-based sidelink communication with the second terminal over one carrier determined upon negotiation with the second terminal, or the first terminal performs CA-based sidelink communication with the second terminal over at least two carriers determined upon negotiation with the second terminal, or the first terminal performs CA-based sidelink communication with the second terminal over an aggregated carrier of at least two carriers determined upon negotiation with the second terminal.

In summary, in the method according to the embodiments, the first terminal and the second terminal determine the first carrier by negotiation to perform sidelink communication, such that the signaling resource consumption between the terminal and the network device is reduced, and the failure rate of carrier configuration based on sidelink communication between the first terminal and the second terminal is reduced, thus improving the data transmission performance on the sidelink.

For a first terminal being a transmitter terminal (transmit UE (Tx UE)) and a second terminal being a receiver terminal (receive UE (Rx UE)), exemplary embodiments in which the transmitter terminal decides to configure a carrier for a unicast link are provided.

FIG. 11 shows a schematic diagram of a method for determining carriers on a sidelink according to some exemplary embodiments of the present disclosure. Description is given in the embodiments based on an example in which the method is applicable to a terminal, and the method includes at least some of the following processes.

In process 111, a transmitter terminal transmits request information of carrier configuration assistance.

Prior to a carrier used for a unicast link between a transmitter terminal and a receiver terminal is not configured, the transmitter terminal and the receiver terminal perform data transmission over a default carrier or a carrier under configuration-based mapping relationship, e.g., a discovery message, a direct communication request (DCR) message, other PC5-signaling(S) messages, or a PC5-RRC message.

Request information of carrier configuration assistance is information configured to assist the terminal in determining a carrier or a main carrier by negotiation, and is transmitted by the transmitter terminal to the receiver terminal.

In some embodiments, request information of carrier configuration assistance is transmitted by the transmitter terminal in the case that at least one of the following conditions is satisfied.
Upon capability interaction, the transmitter terminal confirms that the receiver terminal has a CA, DC, or multi-carrier sidelink communication capability.
The transmitter terminal and the receiver terminal establish a unicast communication link.
The transmitter terminal has not transmitted request information of carrier configuration assistance.
The data transmission between the transmitter terminal and the receiver terminal changes.
The transmitter terminal has performed resource reselection.
The transmitter terminal has performed carrier reselection.

In some embodiments, request information of carrier configuration assistance includes at least one of: request indication, or data characteristics of the to-be-transmitted data, e.g., QoS information, a traffic pattern, or a priority.

In some embodiments, process 111 is not performed by the transmitter terminal, and process 113 is performed directly by the receiver terminal.

In process 113, a receiver terminal transmits carrier configuration assistance information.

Carrier configuration assistance information is information configured to assist the terminal in determining a carrier or a main carrier by negotiation, and is transmitted by the receiver terminal to the transmitter terminal.

In some embodiments, carrier configuration assistance information is transmitted by the receiver terminal in the case that at least one of the following trigger modes is satisfied.
Receiving request information of carrier configuration assistance from transmitter terminal.
A periodically triggered mode.
An event-triggered mode.

In some embodiments, the receiver terminal confirms that the transmitter terminal has a CA, DC, or multi-carrier sidelink communication capability, and periodically transmits carrier configuration assistance information to the transmitter terminal. The period value may be a fixed value, or a default value, or a value configured by the network device, or a value configured by the receiver terminal, or a value autonomously determined by the transmitter terminal.

In some embodiments, the receiver terminal confirms that the transmitter terminal has a CA, or DC, or multi-carrier sidelink communication capability, and transmits carrier configuration assistance information to the transmitter terminal in the case that at least one of the following events occurs.
A desired carrier or carrier set changes.
The transmitter terminal and the receiver terminal establish a unicast communication link.
The receiver terminal has not transmitted carrier configuration assistance information.
Carriers of links other than the sidelink change.
The link quality of the sidelink deteriorates.
Conflict is detected on the sidelink.

In some embodiments, carrier configuration assistance information is generated by the receiver terminal with reference to at least one of: information carried in request information of carrier configuration assistance; carriers used by links other than the sidelink; and the link quality or channel condition of the candidate carrier.

In some embodiments, carrier configuration assistance information includes a carrier or carrier set desired by the receiver terminal.

In some embodiments, process 113 is not performed by the receiver terminal, and process 115 is performed directly by the transmitter terminal.

In process 115, the transmitter terminal configures a first carrier.

The transmitter terminal performs carrier configuration based on the received carrier configuration assistance information, and transmits the configuration to the receiver terminal.

The carrier may be autonomously selected or generated by the transmitter terminal, or configured by the network device for the transmitter terminal.

The carrier may be one carrier on the sidelink, or at least two carriers on the sidelink, or an aggregated carrier of at least two carriers on the sidelink.

In process 117, the receiver terminal accepts or rejects first carrier configuration.

The receiver terminal determines to accept the first carrier configuration transmitted by the transmitter terminal, or determines to reject the first carrier configuration transmitted by the transmitter terminal, or directly performs the first carrier configuration and the configuration fails, or directly performs the first carrier configuration and the configuration fails.

In some embodiments, the receiver terminal transmits a configuration response to the transmitter terminal, e.g., configuration acceptance, configuration rejection, configuration success, or configuration failure.

In process 119, in the case that the receiver terminal rejects configuration or configuration fails, the transmitter terminal performs carrier reconfiguration.

In the case that the configuration response received by the transmitter terminal indicates that the receiver terminal rejects configuration or configuration fails, the transmitter terminal performs at least one of carrier reconfiguration, RLF, or link disconnection.

The carrier reconfiguration is the processing that the transmitter terminal and the receiver terminal repeat at least one of process 111, process 113, process 115, or process 117 to perform carrier configuration in the case that the receiver terminal rejects configuration or configuration fails.

Upon successful carrier configuration, or upon successful carrier reconfiguration, the transmitter terminal and the receiver terminal perform CA-based sidelink communication over the configured carrier or main carrier.

For a first terminal being a receiver terminal, a second terminal being a transmitter terminal, exemplary embodiments in which the receiver terminal decides to configure a carrier for a unicast link are provided.

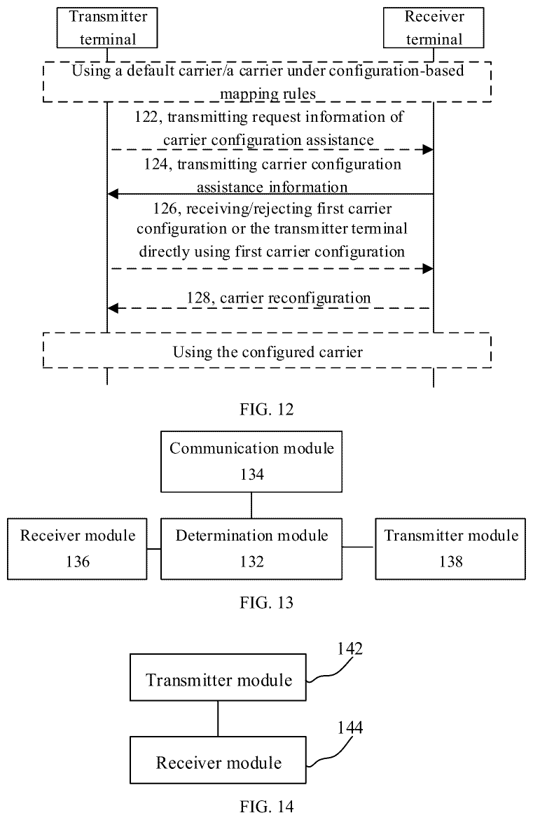

FIG. 12 shows a schematic diagram of a method for determining carriers according to some exemplary embodiments of the present disclosure. Description is given in the embodiments based on an example in which the method is applicable to a terminal, and the method includes at least some of the following processes.

In process 122, a transmitter terminal transmits request information of carrier configuration assistance.

Prior to a carrier used for a unicast link between a transmitter terminal and a receiver terminal is not configured, the transmitter terminal and the receiver terminal perform data transmission over a default carrier or a carrier under configuration-based mapping relationship, e.g., a discovery message, or a DCR message, other PC5-S messages, or a PC5-RRC message.

Request information of carrier configuration assistance is information configured to assist the terminal in determining a carrier or a main carrier by negotiation, and is transmitted by the transmitter terminal to the receiver terminal.

In some embodiments, request information of carrier configuration assistance is transmitted by the transmitter terminal in the case that at least one of the following conditions is satisfied.
Upon capability interaction, the transmitter terminal confirms that the receiver terminal has a CA, or DC, or multi-carrier sidelink communication capability.
The receiver terminal and the transmitter terminal establish a unicast communication link.
The transmitter terminal has not transmitted request information of carrier configuration assistance.
The data transmission between the receiver terminal and the transmitter terminal changes.
The transmitter terminal has performed resource reselection.
The transmitter terminal has performed carrier reselection.

In some embodiments, request information of carrier configuration assistance includes at least one of: request indication, or data characteristics of the to-be-transmitted data, e.g., QoS information, a traffic pattern, or a priority.

In some embodiments, process 122 is not performed by the transmitter terminal, and process 124 is performed directly by the receiver terminal.

In process 124, a receiver terminal transmits carrier configuration assistance information.

Carrier configuration assistance information is information configured to assist the terminal in determining a carrier or a main carrier by negotiation, and is transmitted by the receiver terminal to the transmitter terminal.

In some embodiments, carrier configuration assistance information is transmitted by the receiver terminal in the case that at least one of the following trigger modes is satisfied:
receiving request information of carrier configuration assistance from transmitter terminal;
a periodically triggered mode; or
an event-triggered mode.

In some embodiments, the receiver terminal confirms that the transmitter terminal has a CA, or DC, or multi-carrier sidelink communication capability, and periodically transmits carrier configuration assistance information to the transmitter terminal. The period value may be a fixed value, or a default value, or a value configured by the network device, or a value configured by the transmitter terminal, or a value autonomously determined by the receiver terminal.

In some embodiments, the receiver terminal confirms that the transmitter terminal has a CA, or DC, or multi-carrier sidelink communication capability, and transmits carrier configuration assistance information to the transmitter terminal in the case that at least one of the following events occurs.
A desired carrier or carrier set changes.
The receiver terminal and the transmitter terminal establish a unicast communication link.
The receiver terminal has not transmitted carrier configuration assistance information.
Carriers of links other than the sidelink change.
The link quality of the sidelink deteriorates.
Conflict is detected on the sidelink.

In some embodiments, carrier configuration assistance information is generated by the receiver terminal with reference to at least one of: information carried in request information of carrier configuration assistance; carriers used by links other than the sidelink; or the link quality or channel condition of the candidate carrier.

In some embodiments, carrier configuration assistance information includes a carrier or carrier set desired by the receiver terminal.

In some embodiments, the carrier configuration is autonomously selected or generated by the receiver terminal, or configured by the network device for the receiver terminal.

In some embodiments, the carrier is one carrier on the sidelink, or at least two carriers on the sidelink, or an aggregated carrier of at least two carriers on the sidelink.

In process 126, the transmitter terminal receives or rejects carrier configuration, or the transmitter terminal directly perform sidelink communication over the configured carrier.

Based on the received carrier configuration assistance information, the transmitter terminal determines to accept the carrier configuration transmitted by the receiver terminal, or determines to reject the carrier configuration transmitted by the receiver terminal, or directly performs the carrier configuration and the configuration succeeds, or directly performs the carrier configuration and the configuration fails.

In some embodiments, the transmitter terminal transmits a configuration response to the receiver terminal, e.g., configuration acceptance, configuration rejection, configuration success, or configuration failure.

In process 128, in the case that the transmitter terminal rejects configuration or configuration fails, the receiver terminal performs carrier reconfiguration.

In the case that a configuration response received by the receiver terminal indicates that the transmitter terminal rejects configuration or configuration fails, the receiver terminal performs at least one of the carrier reconfiguration, RLF, or link disconnection.

The carrier reconfiguration is the processing that the receiver terminal and the transmitter terminal repeat at least one of process 122, process 124, or process 126 to perform carrier configuration in the case that the transmitter terminal rejects configuration or configuration fails.

Upon successful carrier configuration, or upon successful carrier reconfiguration, the receiver terminal and the transmitter terminal perform CA-based sidelink communication over the configured carrier or main carrier.

It should be understood that the method for determining carriers in a sidelink described above may be used alone or in combination. For example:

In some embodiments, the first terminal receives carrier configuration from the network device, determines the first carrier in the carrier configuration based on the carrier configuration and the mapping relationship, and performs sidelink communication with the second terminal over the first carrier.

In some embodiments, the first terminal receives carrier configuration from the network device, determines the first carrier in the carrier configuration by negotiation with the second terminal based on the carrier configuration, and performs sidelink communication with the second terminal over the first carrier.

In some embodiments, the first terminal and the second terminal determine first carrier configuration by negotiation, and the first terminal determines the first carrier in the first carrier configuration based on the mapping relationship, and performs sidelink communication with the second terminal over the first carrier.

In some embodiments, the first terminal and the second terminal determine first carrier configuration by negotiation, the second terminal determines the first carrier in the first carrier configuration based on the mapping relationship, and the first terminal performs sidelink communication with the second terminal over the first carrier.

In some embodiments, the first terminal and the second terminal determine first carrier configuration by negotiation, and the first terminal receives the first carrier from the network device, and performs sidelink communication with the second terminal over the first carrier.

In some embodiments, the first terminal receives carrier configuration from the network device, and the first terminal and the second terminal determine first carrier configuration by negotiation in the carrier configuration; the first terminal determines the first carrier in the first carrier configuration based on the mapping relationship, and performs sidelink communication with the second terminal over the first carrier.

In some embodiments, the first terminal receives carrier configuration from the network device, and the first terminal and the second terminal determine first carrier configuration by negotiation in the carrier configuration; the second terminal determines the first carrier in the first carrier configuration based on the mapping relationship, and the first terminal performs sidelink communication with the second terminal over the first carrier.

In some embodiments, the first terminal and the second terminal determine carrier configuration by negotiation, and the first terminal or the second terminal determines first carrier configuration based on the mapping relationship; the first terminal receives the first carrier from the network device, and performs sidelink communication with the second terminal over the first carrier.

FIG. 13 shows a structural block diagram of an apparatus for determining carriers according to some schematic embodiments of the present disclosure. The apparatus includes at least some of: a determination module 132 or a communication module 134.

The determination module 132 is configured to determine a first carrier.

The communication module 134 is configured to perform sidelink communication with a second terminal over the first carrier.

In some embodiments, the determination module 132 is configured to determine the first carrier based on a mapping relationship.

In some embodiments, the mapping relationship includes at least one of:
a mapping relationship between a service type and a candidate carrier;
a mapping relationship between an application type and a candidate carrier;
a mapping relationship between a layer 2 ID and a candidate carrier;
a mapping relationship between a Tx profile and a candidate carrier;
a mapping relationship between a data transmission type and a candidate carrier;
a mapping relationship between a QoS flow and a candidate carrier;
a mapping relationship between a logical channel and a candidate carrier;
a calculation formula between a layer 2 ID and a candidate carrier;
a mapping relationship between a resource pool and a candidate carrier;
a mapping relationship between a radio bearer and a candidate carrier;
a default set of the candidate carriers;
a mapping relationship between a data priority and a candidate carrier; or
a mapping relationship between a resource pool congestion degree and a candidate carrier.

In some embodiments, the mapping relationship includes at least one of:
a mapping relationship defined by NAS; or
a mapping relationship defined by AS.

In some embodiments, the mapping relationship is configured in at least one of the following manners.
The mapping relationship is pre-configured.
The mapping relationship is configured by a network device.
The mapping relationship is configured by the second terminal.
The mapping relationship is determined autonomously by the determination module 132.

In some embodiments, the mapping relationship is applicable to at least one of the following communication patterns.
The mapping relationship is applicable to unicast communication.
The mapping relationship is applicable to multicast communication.
The mapping relationship is applicable to broadcast communication.

In some embodiments, the apparatus further includes a receiver module 136, wherein the receiver module 136 is configured to receive carrier configuration from the network device, and the determination module 132 is configured to determine the first carrier based on the carrier configuration.

In some embodiments, the carrier configuration is applicable to at least one of the following scenarios.
The network device supports the multi-carrier mechanism of a sidelink.
The apparatus is in a connected state.
The apparatus is in Mode-1 in the sidelink.
The apparatus is in Mode-2 in the sidelink.

In some embodiments, the apparatus further includes a transmitter module 138, wherein the transmitter module 138 is configured to transmit first information to the network device, wherein the first information is configured to assist the network device in configuring the carrier configuration.

In some embodiments, the first information includes at least one of:
a channel measurement result;
capability information of the apparatus;
capability information of the second terminal;
interest of the apparatus;
QOS information of the sidelink;
target layer 2 ID information of the sidelink;
logical channel identification information of the sidelink;
a carrier configuration proposed or desired by the apparatus; or
a carrier configuration proposed or desired by the second terminal.

In some embodiments, the determination module 132 is configured to determine the first carrier by negotiating with the second terminal.

In some embodiments, the transmitter module 138 is configured to transmit carrier configuration to the second terminal, wherein the carrier configuration indicates the first carrier determined by the determination module 132; the receiver module 136 is configured to receive a configuration response of the second terminal; and the communication module 134 is configured to perform sidelink communication with the second terminal over the first carrier in the case that the configuration response is a configuration acceptance.

In some embodiments, the carrier configuration is generated by the determination module 132; or the carrier configuration is configured by the network device for the receiver module 136.

In some embodiments, the apparatus is a transmitter terminal, the second terminal is a receiver terminal, and the receiver module 136 is configured to receive carrier configuration assistance information from the second terminal.

In some embodiments, the carrier configuration assistance information is transmitted by the second terminal in the case that at least one of the following trigger modes is satisfied.
receiving the request information of carrier configuration assistance from the transmitter module 138;
a periodically triggered mode; or
an event-triggered mode.

In some embodiments, the period value is a fixed value, or a default value, or a value configured by the network device, or a value configured by the second terminal, or a value autonomously determined by the determination module 132.

In some embodiments, the event includes at least one of the following events.
A desired carrier or carrier set changes.
The communication module 134 and the second terminal establish a unicast communication link.
The second terminal has not transmitted the carrier configuration assistance information.
Carriers of links other than the sidelink change.
The link quality of the sidelink deteriorates.
Conflict is detected on the sidelink.

In some embodiments, the carrier configuration assistance information is generated by the second terminal with reference to at least one of:
information carried in the request information of carrier configuration assistance;
carriers used by links other than the sidelink; or
link quality or channel condition of a candidate carrier.

In some embodiments, the carrier configuration assistance information includes a carrier or carrier set desired by the second terminal.

In some embodiments, the transmitter module 138 is configured to transmit request information of carrier configuration assistance to the second terminal.

In some embodiments, the request information of carrier configuration assistance is transmitted by the transmitter module 138 to the second terminal in the case that at least one of the following conditions is satisfied.
The second terminal has a carrier aggregation or multi-carrier sidelink communication capability.
The communication module 134 and the second terminal establish a unicast communication link.
The transmitter module 138 has not transmitted the request information of carrier configuration assistance.
The data transmission between the apparatus and the second terminal changes.
The determination module 132 has performed resource reselection.
The determination module 132 has performed carrier reselection.

In some embodiments, the request information of carrier configuration assistance carries at least one of:
a request indication; or
data characteristics of to-be-transmitted data, the data characteristics including at least one of QoS, a traffic pattern, or a priority.

In some embodiments, the apparatus is a receiver terminal, the second terminal is a transmitter terminal, and the carrier configuration is transmitted by the transmitter module 138 to the second terminal in the case that at least one of the following trigger modes is satisfied.
the receiver module 136 receives the request information of carrier configuration assistance from the second terminal;
a periodically triggered mode; or
an event-triggered mode.

In some embodiments, the period value is a fixed value, or a default value, or a value configured by the network device, or a value configured by the second terminal, or a value autonomously determined by the determination module 132.

In some embodiments, the event includes at least one of the following events.
A desired carrier or carrier set changes.
The communication module 134 and the second terminal establish a unicast communication link.
The second terminal has not transmitted the carrier configuration assistance information.
Carriers of links other than the sidelink change.
The link quality of the sidelink deteriorates.
Conflict is detected on the sidelink.

In some embodiments, the carrier configuration is generated by the determination module 132 with reference to at least one of:
information carried in the request information of carrier configuration assistance;
carriers used by links other than the sidelink; or
link quality or channel condition of a candidate carrier.

In some embodiments, the apparatus is a receiver terminal, the second terminal is a transmitter terminal, and the receiver module 136 is configured to receive the request information of carrier configuration assistance from the second terminal.

In some embodiments, the request information of carrier configuration assistance is transmitted by the second terminal in the case that at least one of the following conditions is satisfied.
The apparatus has a carrier aggregation or multi-carrier sidelink communication capability.
The communication module 134 and the second terminal establish a unicast communication link.
The second terminal has not transmitted the request information of carrier configuration assistance.
The data transmission between the communication module 134 and the second terminal changes.
The second terminal has performed resource reselection.
The second terminal has performed carrier reselection.

In some embodiments, the request information of carrier configuration assistance carries at least one of:
a request indication; or
data characteristics of to-be-transmitted data, wherein the data characteristics include at least one of QoS, a traffic pattern, or a priority.

In some embodiments, in the case that the configuration response is a configuration rejection, the determination module 132 performs at least one of reconfiguration, link failure, or link disconnection.

In summary, according to the apparatus provided in the embodiments, by using a more flexible carrier determination and configuration module, with the introduction of CA, a proper carrier may be determined or at least two carriers may be used for CA, such that the data transmission performance on the sidelink is improved, and the transmission performance of the sidelink communication system is enhanced.

FIG. 14 shows a structural block diagram of an apparatus for determining carriers according to some schematic embodiments of the present disclosure. The apparatus includes at least some of the following modules: a transmitter module 142.

The transmitter module 142 is configured to transmit carrier configuration to a first terminal, wherein the carrier configuration is configured for the first terminal to determine a first carrier to perform sidelink communication with a second terminal.

In some embodiments, the carrier configuration is applicable to at least one of the following scenarios.
The apparatus supports the multi-carrier mechanism of a sidelink.
The terminal is in a connected state.
The terminal is in Mode-1 in the sidelink.
The terminal is in Mode-2 in the sidelink.

In some embodiments, the apparatus further includes a receiver module 144, wherein the receiver module 144 is configured to receive first information from the first terminal, wherein the first information is configured to assist the transmitter module 142 in configuring the carrier configuration.

In some embodiments, the first information includes at least one of:
a channel measurement result;
capability information of the first terminal;
capability information of the second terminal;
interest of the first terminal;
QOS information of the sidelink;
target layer 2 ID information of the sidelink;
logical channel identification information of the sidelink;
a carrier configuration proposed or desired by the first terminal; or
a carrier configuration proposed or desired by the second terminal.

In summary, the apparatus provided in the embodiments controls or configures carrier resources for the first terminal, and then the first terminal determines the first carrier to perform sidelink communication based on the carrier configuration. The apparatus coordinates the carrier configuration of different terminals, such that the success rate and stability of the carrier configuration on the sidelink are improved, and thus the transmission performance of the sidelink communication system is enhanced.

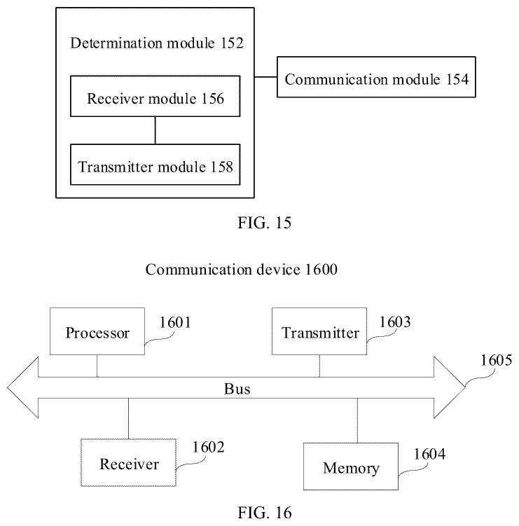

FIG. 15 shows a structural block diagram of an apparatus for determining carriers according to some schematic embodiments of the present disclosure. The apparatus includes at least some of the following modules: a determination module 152 and a communication module 154.

The determination module 152 is configured to determine a first carrier by negotiating with a first terminal. The communication module 154 is configured to perform sidelink communication with the first terminal over the first carrier.

In some embodiments, the determination module 152 includes a receiver module 156, wherein the receiver module 156 is configured to receive carrier configuration from the first terminal, wherein the carrier configuration indicates the first carrier determined by the first terminal.

The determination module 152 includes a transmitter module 158, wherein the transmitter module 158 is configured to transmit a configuration response to the first terminal, wherein the configuration response includes a configuration acceptance or a configuration rejection.

In some embodiments, the carrier configuration is generated by the first terminal; or the carrier configuration is configured to the first terminal by the network device.

In some embodiments, the first terminal is a transmitter terminal, the apparatus is a receiver terminal, and the transmitter module 158 transmits carrier configuration assistance information to the first terminal.

In some embodiments, the transmitter module 158 is configured to transmit carrier configuration assistance information to the first terminal, including:
the transmitter module 158 being configured to transmit the carrier configuration assistance information to the first terminal in the case that at least one of the following trigger modes is satisfied:
the receiver module 156 receives request information of carrier configuration assistance from the first terminal;
a periodically triggered mode; or
an event-triggered mode.

In some embodiments, the period value is a fixed value, or a default value, or a value configured by the network device, or a value configured by the first terminal, or a value autonomously determined by the determination module 152.

In some embodiments, the event includes at least one of the following events.
A desired carrier or carrier set changes.
The first terminal and the communication module 154 establish a unicast communication link.
The transmitter module 158 has not transmitted the carrier configuration assistance information.
Carriers of links other than the sidelink change.
The link quality of the sidelink deteriorates.
Conflict is detected on the sidelink.

In some embodiments, the determination module 152 is configured to generate the carrier configuration assistance information with reference to at least one of the following information.
Information carried in the request information of carrier configuration assistance.
Carriers used by links other than the sidelink.
Link quality or channel condition of a candidate carrier.

In some embodiments, the carrier configuration assistance information includes a carrier or carrier set desired by the determination module 152.

In some embodiments, the receiver module 156 is configured to receive request information of carrier configuration assistance from the first terminal.

In some embodiments, the request information of carrier configuration assistance is transmitted by the first terminal in the case that at least one of the following conditions is satisfied.
The apparatus has a carrier aggregation or multi-carrier sidelink communication capability.
The first terminal and the communication module 154 establish a unicast communication link.
The first terminal has not transmitted the request information of carrier configuration assistance.
The data transmission between the first terminal and the communication module 154 changes.
The first terminal has performed resource reselection.
The first terminal has performed carrier reselection.

In some embodiments, the request information of carrier configuration assistance carries at least one of:
a request indication; or
data characteristics of to-be-transmitted data, the data characteristics including at least one of quality of service (QOS), a traffic pattern, or a priority.

In some embodiments, the first terminal is a receiver terminal, the apparatus is a transmitter terminal, and the carrier configuration is transmitted by the first terminal in the case that at least one of the following trigger modes is satisfied.
receiving request information of carrier configuration assistance from the transmitter module 158;
a periodically triggered mode; or
an event-triggered mode.

In some embodiments, the period value is a fixed value, or a default value, or a value configured by the network device, or a value configured by the first terminal, or a value autonomously determined by the determination module 152.

In some embodiments, the event includes the following items:
a desired carrier or carrier set changes;
the first terminal and the communication module 154 establish a unicast communication link;
the communication module 154 has not transmitted the carrier configuration assistance information;
carriers of links other than the sidelink change;
the link quality of the sidelink deteriorates; and
conflict is detected on the sidelink.

In some embodiments, the carrier configuration is generated by the first terminal with reference to at least one of:
information carried in the request information of carrier configuration assistance;
carriers used by links other than the sidelink; or
link quality or channel condition of a candidate carrier.

In some embodiments, the first terminal is a receiver terminal, the apparatus is a transmitter terminal, and the transmitter module 158 is configured to transmit request information of carrier configuration assistance to the first terminal.

In some embodiments, the transmitter module 158 is configured to transmit request information of carrier configuration assistance to the first terminal, including:

the transmitter module 158 being configured to transmit the request information of carrier configuration assistance to the first terminal in the case that at least one of the following triggering conditions is satisfied.
The first terminal has a carrier aggregation or multi-carrier sidelink communication capability.
The first terminal and the communication module 154 establish a unicast communication link.
The transmitter module 158 has not transmitted the request information of carrier configuration assistance.
The data transmission between the first terminal and the communication module 154 changes.
The determination module 152 has performed resource reselection.
The determination module 152 has performed carrier reselection.

In some embodiments, the request information of carrier configuration assistance carries at least one of:
a request indication; or
data characteristics of to-be-transmitted data, the data characteristics including at least one of QoS, a traffic pattern, or a priority.

The apparatus described above is applicable to sidelink communication scenarios based on Mode-1 and/or sidelink communication scenarios based on Mode-2.

In summary, according to the apparatus provided in the embodiments, by using a more flexible carrier determination and configuration module, with the introduction of CA, a proper carrier may be determined or at least two carriers may be used for CA, such that the data transmission performance on the sidelink is improved, and the transmission performance of the sidelink communication system is enhanced.

It should be noted that, for the apparatus according to the embodiments described above, the division of the functional modules is merely exemplary. In practice, the functions described above may be assigned to and completed by different functional modules as needed, that is, the internal structure of the apparatus may be divided into different functional modules, to implement all or a part of the above functions.

With regard to the apparatus in the embodiments, the specific manner in which each module performs the operation has been described in detail in the embodiments related to the method and will not be described in detail herein.

FIG. 16 shows a schematic structural diagram of a communication device (a terminal device or a network device) according to some exemplary embodiments of the present disclosure. The communication device 1600 includes: a processor 1601, a receiver 1602, a transmitter 1603, a memory 1604, and a bus 1605.

The processor 1601 includes one or more processing cores, and the processor 1601 runs various functional applications and performs information processing by running software programs and modules.

The receiver 1602 and the transmitter 1603 are implemented as a communication assembly. The communication assembly may be a communication chip.

The memory 1604 is connected to the processor 1601 by the bus 1605. The memory 1604 is configured to store at least one instruction, and the processor 1601, when loading and executing the at least one instruction, is caused to perform the processes in the above method embodiments.

In addition, the memory 1604 may be implemented using any type of volatile or non-volatile storage device, or a combination of both. Volatile or non-volatile storage devices include, but are not limited to: a disk or optical disc, an electrically erasable programmable read-only memory (EEPROM), an erasable programmable read-only memory (EPROM), a static random-access memory (SRAM), a read-only memory (ROM), a magnetic memory, a flash memory, or a programmable read-only memory (PROM).

In some exemplary embodiments, a computer-readable storage medium is further provided. The computer-readable storage medium stores at least one program. The at least one program, when loaded and run by the processor, causes the processor to perform the method for determining carriers according to the method embodiments described above.

In some exemplary embodiments, a chip is further provided. The chip includes one or more programmable logic circuits and/or one or more program instructions. The chip, when running on the communication device, is caused to perform the method for determining carriers according to the method embodiments described above.

In some exemplary embodiments, a computer program product is further provided. The computer program product, when running on a processor of a computer device, causes the computer device to perform the method for determining carriers described above.

In some exemplary embodiments, a communication system is further provided. The communication system includes the first terminal, the second terminal, and the network device described above, and is configured to perform the method for determining carriers according to the method embodiments described above.

Those skilled in the art should understand that in one or more of the above embodiments, the functions described in the embodiments of the present disclosure may be implemented in hardware, software, firmware, or any combination thereof. The functions, when implemented in software, may be stored in a computer-readable medium or transmitted as one or more instructions or codes on a computer-readable medium. The computer-readable medium includes a computer storage medium and a communication medium, wherein the communication medium includes any medium that facilitates the transfer of a computer program from one place to another. The storage medium is any available medium that is accessible by a general-purpose or special-purpose computer.

Described above are merely exemplary embodiments of the present disclosure and are not intended to limit the present disclosure. Any modifications, equivalent substitutions, improvements, and the like, made within the spirit and principle of the present disclosure should fall within the protection scope of the present disclosure.

1. A method for determining carriers, applicable to a first terminal, the method comprising:
determining a first carrier; and
performing sidelink communication with a second terminal over the first carrier.

2. The method according to claim 1, wherein determining the first carrier comprises:
determining the first carrier based on a mapping relationship.

3. The method according to claim 2, wherein the mapping relationship comprises at least one of:
a mapping relationship between a service type and a candidate carrier;
a mapping relationship between an application type and a candidate carrier;
a mapping relationship between a layer 2 identity (ID) and a candidate carrier;
a mapping relationship between a Tx profile and a candidate carrier;
a mapping relationship between a data transmission type and a candidate carrier;
a mapping relationship between a quality of service (QOS) flow and a candidate carrier;
a mapping relationship between a logical channel and a candidate carrier;
a calculation formula between a layer 2 ID and a candidate carrier;
a mapping relationship between a resource pool and a candidate carrier;
a mapping relationship between a radio bearer and a candidate carrier;
a default set of candidate carriers;
a mapping relationship between a data priority and a candidate carrier; or
a mapping relationship between a resource pool congestion degree and a candidate carrier.

4. The method according to claim 3, wherein the mapping relationship comprises at least one of:
a mapping relationship defined by a non-access stratum; or
a mapping relationship defined by an access stratum.

5. The method according to claim 2, wherein the mapping relationship is configured in at least one of the following manners:
the mapping relationship is pre-configured;
the mapping relationship is configured by a network device;
the mapping relationship is configured by the second terminal; or
the mapping relationship is determined by the first terminal.

6. The method according to claim 5, wherein the mapping relationship is applicable to at least one of:
unicast communication;
multicast communication; or
broadcast communication.

7. The method according to claim 1, wherein determining the first carrier comprises:
receiving a carrier configuration from a network device; and
determining the first carrier based on the carrier configuration.

8. The method according to claim 7, wherein the carrier configuration is applicable to at least one of the following scenarios:
the network device supports a multi-carrier mechanism of a sidelink;
the terminal is in a connected state;
the terminal is in mode 1 in a sidelink; or
the terminal is in mode 2 in a sidelink.

9. The method according to claim 7, further comprising:
transmitting first information to the network device, wherein the first information is configured to assist the network device in configuring the carrier configuration.

10. The method according to claim 9, wherein the first information comprises at least one of:
a channel measurement result;
capability information of the first terminal;
capability information of the second terminal;
interest of the first terminal;
quality of service (QOS) information of a sidelink;
target layer 2 identity (ID) information of a sidelink;
logical channel identification information of a sidelink;
a carrier configuration proposed or desired by the first terminal; or
a carrier configuration proposed or desired by the second terminal.

11. The method according to claim 1, wherein determining the first carrier comprises:
determining the first carrier by negotiating with the second terminal.

12. The method according to claim 11, wherein determining the first carrier by negotiating with the second terminal comprises:
transmitting a carrier configuration to the second terminal, wherein the carrier configuration indicates the first carrier determined by the first terminal; and
receiving a configuration response of the second terminal; and
wherein performing sidelink communication with the second terminal over the first carrier comprises:
performing sidelink communication with the second terminal over the first carrier in a case that the configuration response is a configuration acceptance.

13. The method according to claim 12, wherein the carrier configuration is generated by the first terminal; or
the carrier configuration is configured for the first terminal by a network device.

14. A method for determining carriers, applicable to a second terminal, the method comprising:
determining a first carrier by negotiating with a first terminal; and
performing sidelink communication with the first terminal over the first carrier.

15. The method according to claim 14, wherein determining the first carrier by negotiating with the first terminal comprises:
receiving a carrier configuration from the first terminal, wherein the carrier configuration indicates the first carrier determined by the first terminal; and
transmitting a configuration response to the first terminal, wherein the configuration response comprises a configuration acceptance or a configuration rejection.

16. A first terminal, comprising:
a processor;
a transceiver, communicably connected to the processor; and
a memory, configured to store one or more executable instructions, which when executed by the processor, cause the first terminal to perform the method of claim 1.

17. A network device, comprising:
a processor;
a transceiver, communicably connected to the processor; and
a memory, configured to store one or more executable instructions, which when executed by the processor, cause the processor to:
transmit a carrier configuration to a first terminal, wherein the carrier configuration is configured for the first terminal to determine a first carrier to perform sidelink communication with a second terminal.

18. The network device according to claim 17, wherein the carrier configuration is applicable to at least one of the following scenarios:
the network device supports a multi-carrier mechanism of a sidelink;
the terminal is in a connected state;
the terminal is in mode 1 in a sidelink; or
the terminal is in mode 2 in a sidelink.

19. The network device according to claim 17, wherein the processor, when loading and executing the one or more executable instructions, is further caused to:
receive first information from the first terminal, wherein the first information is configured to assist the network device in configuring the carrier configuration.

20. The network device according to claim 19, wherein the first information comprises at least one of:
a channel measurement result;
capability information of the first terminal;
capability information of the second terminal;
interest of the first terminal;
quality of service (QOS) information of a sidelink;
target layer 2 identity (ID) information of the sidelink;
logical channel identification information of a sidelink;
a carrier configuration proposed or desired by the first terminal; or
a carrier configuration proposed or desired by the second terminal.
